(19) United States
(12) Patent Application Publication
(10) Pub. No.: US 2004/0105209 A1
(43) Pub. Date: Jun. 3, 2004

(54) Circuitry configuration for an electromagnetic regeneration valve actuable by pulse-width modulation for venting the tank of a motor vehicle

(75) Inventors: Torsten Gerlich, Bensheim (DE); Christopher Klatt, Heidelberg (DE); Ralf Heinrich, Weinheim (DE); Christoph Klesen, Modautal (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/665,137

(22) Filed: Sep. 18, 2003

(30) Foreign Application Priority Data
Sep. 20, 2002 (DE) 102 43 956.7-13

(51) Int. Cl. H01H 47/00

(52) U.S. Cl. 361/139

(57) ABSTRACT

A circuitry configuration for an electromagnetic regeneration valve actuatable by pulse-width modulation for venting the tank of a motor vehicle is described, having a power source for supplying the solenoid of the regeneration valve with electricity, a control unit for generating pulse-width-modulated signals and a switching device via which the solenoid is able to receive the pulse-width-modulated signals of the control unit. Means are provided for suppressing high induced voltages at the solenoid. This measure considerably reduces the noise generation during operation of the regeneration valve, both in pulsed and in proportional mode.

Priority is claimed to German Patent Application DE 102 43 956.7-13, filed on Sep. 20, 2002, the entire disclosure of which is incorporated by reference herein.

### BACKGROUND

The present invention relates to a circuitry configuration for an electromagnetic regeneration valve actuatable by pulse-width modulation for venting the tank of a motor vehicle, having a source for supplying the solenoid of the regeneration valve with electricity, a control unit for generating pulse-width-modulated signals and a switching device via which the solenoid is able to receive the pulse-width-modulated signals of the control unit.

A method is known for trapping the volatile fuel vapors in a vehicle's fuel tank system, storing them and then routing them in metered quantities to the inlet pipe of the vehicle's internal combustion engine. As a general rule, an activated carbon canister is used as the device for trapping and storing the fuel vapors. Activated carbon binds (adsorbs) the fuel vapor and when subjected to an appropriate flow of air, releases it once again. During driving, therefore, fresh air is aspirated by the engine through the activated carbon canister, picking up the fuel and supplying it to the engine. The fuel-air mixture is metered via a regeneration valve. A regeneration valve normally consists of an electromagnetically operated valve, which includes a solenoid, an armature with a sealing element, a seat and a return spring (closing spring). When current flows, the magnetic force of the coil causes the armature to lift the sealing element off the seat, against the force of the closing spring, thus opening the valve orifice. The valve is then in its open position. When no current is flowing, the sealing element is pressed onto the seat by the closing spring, and the valve is then in its closed position.

Activation of the regeneration valve takes place by way of the engine controller, which determines the maximum air-fuel mass flow that can be metered into the internal combustion engine, on the basis of the load on the engine at any given moment, converting this into an appropriate control signal. In this process the regeneration valve generally receives pulsed (pulse-width-modulated) activation, and in response to the duty factor stipulated by the engine controller at any given moment supplies differing metered quantities on a discontinuous basis. In this context, “duty factor” is understood as the ratio of the total valve period, i.e., the period of the open and the closed valve, to the period of the open valve.

In order to avoid an oscillating movement of the magnetic armature with the sealing element between the open and the closed position, this movement entailing certain disadvantages, a method is also known of operating the pulsed regeneration valve in a proportional mode, for example from International Patent Application WO 99/06893, the entire disclosure of which is incorporated by reference. In this method, the pulse frequency is set to such a high level that the valve can no longer react to the oscillating activation and instead remains in a position, which corresponds to the mean current level in the coil at that moment.

A disadvantage in the known regeneration valves as described above is that both the pulsed and the pulse-width modulated proportional operation modes result in generation of undesirable noise, which to date it has not been possible to prevent.

### SUMMARY OF THE INVENTION

An object of the present invention is to provide a circuitry configuration for an electromagnetic regeneration valve for venting the tank of a motor vehicle via which the generation of noise both in the pulsed and the proportional operation modes can be considerably reduced.

The present invention provides a circuitry configuration for an electromagnetic regeneration valve actuatable by pulse-width modulation for venting the tank of a motor vehicle. The ciruitry configuration has a power source for supplying the solenoid of the regeneration valve with electricity, a control unit for generating pulse-width-modulated signals and a switching device via which the solenoid is able to receive the pulse-width-modulated signals of the control unit. In addition a device is provided for suppressing high induced voltages at the solenoid.

According to the present invention, a device is provided for suppressing high induced voltages at the solenoid in a circuitry configuration for an electromagnetic regeneration valve actuatable by pulse-width modulation for venting the tank of a motor vehicle and having a power source for supplying the solenoid of the regeneration valve with electricity, a control unit for generating pulse-width-modulated signals and a switching device via which the solenoid is able to receive the pulse-width-modulated signals of the control unit. In the simplest case, such a device may have a free-wheeling diode, connected in parallel to the solenoid.

Surprisingly it has been found that if a free-wheeling diode is connected in parallel to the solenoid, a considerable reduction in valve noise can be achieved. The use of free-wheeling diodes is a known process in valve engineering and generally serves the purpose of protecting the power circuit breakers which control the coil current against the high induced voltages which occur as the valve reverses. It is also known that this measure results in undesirable lengthening of the coil reaction time. German Patent 196 52 391, which is incorporated by reference herein, therefore provides for measures to restore rapid coil reaction. However, one result of this is evidently to quiet the movement of the solenoid valve to a degree which is sufficient to reduce significantly the severe noise generation which otherwise normally occurs. This applies both to the proportional and the pulsed operation modes of the valve.

It is advantageous if the regeneration valve in the circuitry configuration according to the present invention is actuated in proportional mode with a pulse frequency of between 20 Hz and 200 Hz. It has been shown that with the pulsed proportional valves normally used, the valve characteristic curve (mass flow as a function of pulse-length) becomes steeper and less linear as the pulse frequency is increased, leading to a deterioration in metering accuracy. The explanation for this response is that, on the one hand, the inductivity of the coil causes the current buildup in the coil to be slowed down and, on the other, there is a need to overcome the inertia of the mass to be moved. With increasing pulse frequency, therefore, a higher current in the coil is needed to open the valve gap. It is advantageous if the pulse frequency in proportional mode is approximately 50 Hz. It has been shown that this frequency is adequate to guarantee virtual proportional operation, in which there is always a flow of current through the coil and thus there is no impact by the armature of the valve.

The circuitry configuration according to the present invention has the advantage that the electronic activation devices currently present in motor vehicles can be left unchanged, which must be considered as a clear cost advantage, since nothing stands in the way of using the circuitry configuration in existing vehicle ranges. The circuitry configuration according to the present invention may be used both for pulsed and for proportional operation modes.

### BRIEF DESCRIPTION OF THE DRAWINGS

The present invention is described in greater detail below on the basis of the drawings, in which:

FIG. 1 shows a block diagram of a preferred embodiment of the present invention;

FIG. 2 shows the curves of the current in the solenoid at a pulse frequency of 50 Hz and differing on-periods, with and without a free-wheeling diode; and

FIG. 3 shows the armature movement corresponding to the curves in FIG. 2.

### DETAILED DESCRIPTION

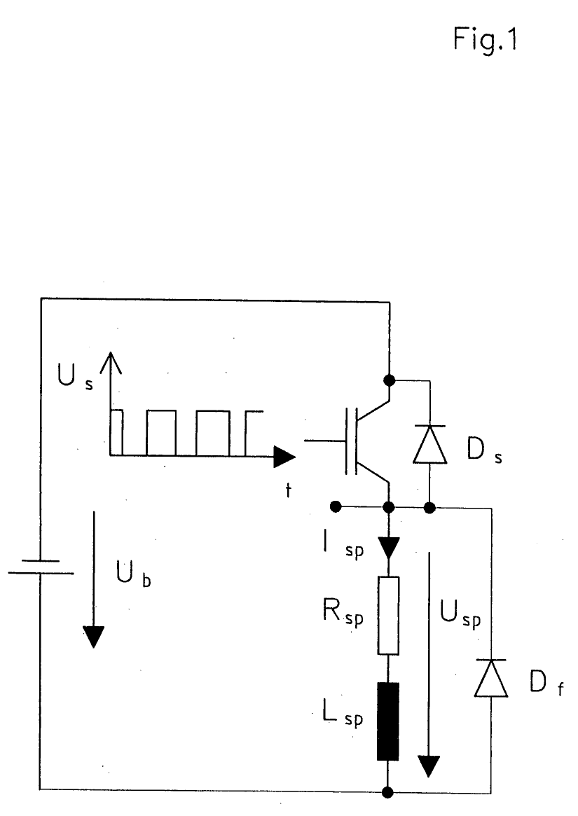

FIG. 1 shows the block diagram of the activation for the regeneration valve. The valve's magnetic circuit is represented by resistor Rₛₚ and inductance Lₛₚ. Free-wheeling diode D_{f} according to the present invention is shown in parallel with this. The power transistor, incorporating a diode Dₛ for protection purposes, is activated with control pulses of a constant frequency and variable pulse width, causing it to connect the battery or the vehicle's electrical system U_{b} to the valve. Control is generally provided by the engine controller. The pulse-width-modulated activation of a solenoid valve, in particular of one in a motor vehicle, is a known process, which has been frequently described, and in consequence no further detail will be given here.

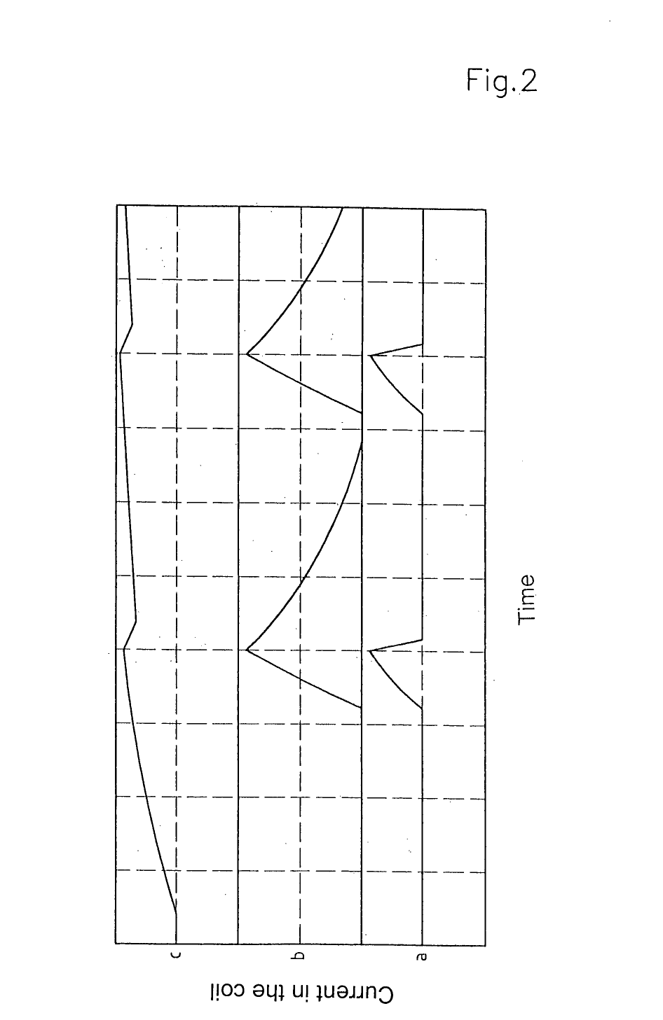

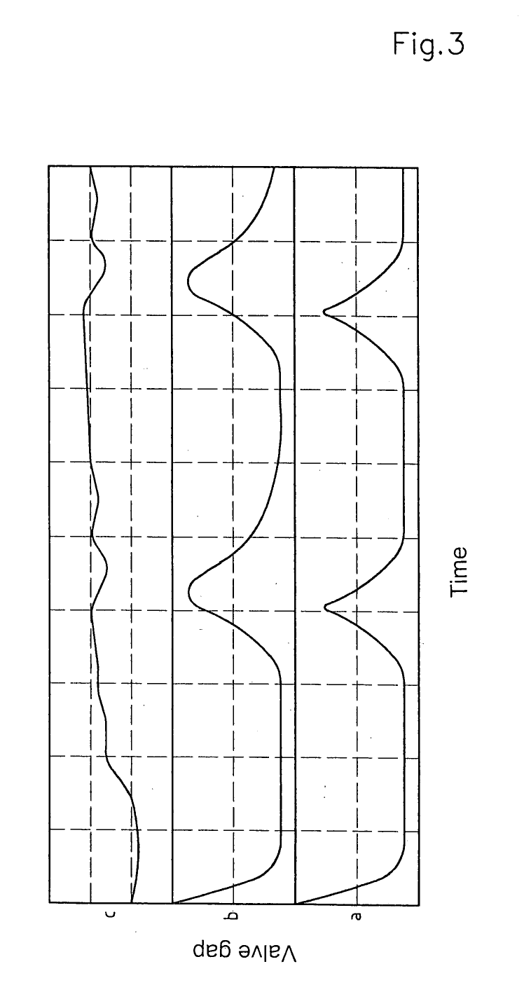

FIG. 2 shows, as an example, the curves of the current in the solenoid at a pulse frequency of 50 Hz in proportional mode and (a) without a free-wheeling diode and with an on-period of 20%, (b) with a free-wheeling diode and with an on-period of 20% and (c) with a free-wheeling diode and with an on-period of 90%. It will be seen that the decay is significantly slowed down when the free-wheeling diode is present. With an on-period of 90% the current through the coil is always greater than 0. The effects on the movement of the armature are shown in FIG. 3. With an on-period of 20%, the curve (a) without a free-wheeling diode is clearly sharper than that when a free-wheeling diode is present (b). In particular, the armature returns very rapidly to its resting position, which is evidently the cause of the severe noise generation. In the embodiment with the diode, the valve closes extremely gently, and noise generation is significantly reduced. With an on-period of 90% with a free-wheeling diode (c), the valve does not even close any more. This results in a complete absence of noise.

The conclusion from the above is that the circuitry configuration according to the invention results in a significant reduction in noise generation not only in proportional mode at high pulse frequencies but also in pulsed mode, as a result of the slow current decay after a pulse.

What is claimed is:

1. A circuitry configuration for an electromagnetic regeneration valve for venting a tank of a motor vehicle, the regeneration valve being actuatable by pulse-width modulation and including a solenoid, the circuitry configuration comprising:
a power source for supplying the solenoid with electricity;
a control unit for generating pulse-width-modulated signals;
a switching device, the solenoid capable of receiving the pulse-width-modulated signals of the control unit via the switching device; and
a suppression device for suppressing high induced voltages at the solenoid.

2. The circuitry configuration as recited in claim 1, wherein the suppression device includes a free-wheeling diode connected in parallel to the solenoid.

3. The circuitry configuration as recited in claim 1, wherein the regeneration valve is actuatable in a proportional mode with a pulse frequency of between 20 Hz and 200 Hz.

4. The circuitry configuration as recited in claim 3, wherein the regeneration valve is actuatable with a pulse frequency of about 50 Hz.

5. The circuitry configuration as recited in claim 1, wherein the power source includes the vehicle's electrical system.

6. The circuitry configuration as recited in claim 1, wherein the control unit includes the engine controller.

7. The circuitry configuration as recited in claim 1, wherein the switching device includes a power transistor.

8. The circuitry configuration as recited in claim 7, further comprising a further diode connected in parallel to the power transistor.
